(19) United States
(12) Patent Application Publication
(10) Pub. No.: US 2024/0313445 A1
(43) Pub. Date: Sep. 19, 2024

(54) CONNECTOR DEVICE AND METHOD FOR MATING CONNECTOR DEVICE WITH MATING CONNECTOR DEVICE

(71) Applicant: JAPAN AVIATION ELECTRONICS INDUSTRY, LIMITED, Tokyo (JP)

(72) Inventors: Junji OOSAKA, Tokyo (JP); Yohei YOKOYAMA, Tokyo (JP); Yosuke HONDA, Tokyo (JP); Akihiro MATSUNAGA, Tokyo (JP)

(73) Assignee: JAPAN AVIATION ELECTRONICS INDUSTRY, LIMITED, Tokyo (JP)

(21) Appl. No.: 18/430,677

(22) Filed: Feb. 2, 2024

(30) Foreign Application Priority Data
Mar. 14, 2023 (JP) 2023-039624

(51) Int. Cl. H01R 12/71; H01R 12/79; H01R 13/631

(52) U.S. Cl. CPC H01R 12/716; H01R 12/79; H01R 13/631

(57) ABSTRACT

A connector device is provided with a substrate and a connector joined to the substrate. The substrate is provided with a through hole which pierces the substrate. The connector has a mounting surface, and the mounting surface is directed to the substrate. The mounting surface is formed with a visual recognition mark. The visual recognition mark is visually recognizable through the through hole.

### CROSS REFERENCE TO RELATED APPLICATIONS

This application is based on and claims priority under 35 U.S.C. § 119 to Japanese Patent Application No. JP2023-039624 filed Mar. 14, 2023, the contents of which are incorporated herein in their entirety by reference.

### BACKGROUND OF THE INVENTION

This invention relates to a connector device and to a method for mating the connector device with a mating connector device.

JP 2016-096079A (Patent Document 1) discloses a technique which allows electrical connectors to be smoothly mated with each other in a state that the electrical connectors are easily and certainly aligned by using simple structure.

Referring to FIG. 10, a first electrical connector 91 of Patent Document 1 is mounted on a first wiring substrate 93. On a rear surface of the first wiring substrate 93, a reinforcing plate 95 is attached. A second electrical connector 97 is provided on a second wiring substrate 99. The first electrical connector 91 and the second electrical connector 97 can be mated with each other by facing each other and bringing them close to each other.

As shown in FIG. 10, the reinforcing plate 95 is provided with dent portions 953, which are positioned at opposite end portions 951 in a pitch direction. The first wiring substrate 93 is also provided with dent portions corresponding to the dent portions 953, respectively. With this structure, a part, or each end portion, of the first electrical connector 91 is visible. Accordingly, when the first electrical connector 91 and the second electrical connector 97 are mated with each other, alignment of the first electrical connector 91 with respect to the second electrical connector 97 can be easily and certainly carried out.

When the first electrical connector 91 is removed from the second electrical connector 97, upward forces are applied to the end portions 951 in the pitch direction of the reinforcing plate 95 by fingers which are hooked to the end portions 951. The reinforcing plate 95 is provided with the dent portions 953 in the end portions 951 in the pitch direction, so that a width size of the part of each of the end portions 951 to which the finger is hooked is small. Accordingly, when the first electrical connector 91 is removed from the second electrical connector 97, a stress is concentrated at a root portion of each of the end portions 951 of the reinforcing plate 95. Therefore, the reinforcing plate 95 may be damaged. Such damage can be avoided by increasing a width size of the reinforcing plate 95. However, this causes an increase in a size of the reinforcing plate and then an increase in a size of the connector device.

### SUMMARY OF THE INVENTION

It is an object of the present invention to provide a connector device which is provided with a structure which can give a predetermined strength to a reinforcing plate or a substrate without increasing a size thereof and which allows connectors to be easily aligned with each other.

One aspect of the present invention provides a connector device which comprises a substrate and a connector which is joined to the substrate. The substrate is provided with a through hole which pierces the substrate in an up-down direction and is closed in a plane perpendicular to the up-down direction. The connector has a fitting portion which is mateable with a mating connector positioned downward of the connector in the up-down direction and a mounting surface which is a reverse of the fitting portion. The mounting surface faces the substrate. The mounting surface is formed with a visual recognition mark which is image-recognizable. The visual recognition mark is visually recognizable through the through hole.

Another aspect of the present invention provides a method for mating the aforementioned connector device with a mating connector device. The mating connector device comprises a mating substrate and the mating connector fixed on the mating substrate. The method comprises: image-recognizing the connector device and the mating connector device positioned downward of the connector device by using a single image sensor located upward of the connector device; calculating a position of the connector and a position of the mating connector in a horizontal plane perpendicular to the up-down direction, based on a result of the image-recognizing; aligning the position of the connector with the position of the mating connector in the horizontal plane, based on the positions calculated by the calculating; and moving the connector with respect to the mating connector in the up-down direction to mate the connector with the mating connector after the aligning.

In the connector device of the above-mentioned aspect, the visible mark formed on the mounting surface of the connector is visually recognizable through the through hole provided in the substrate. Accordingly, when the connector is mated with the mating connector, a position of the connector with respect to the mating connector is visually recognizable. Therefore, alignment of the connector and the mating connector can be easily carried out.

Moreover, in the connector device of the above-mentioned aspect, the through hole provided in the substrate is closed in the plane perpendicular to the up-down direction. This means that the through hole is away from edges of the substrate. In other words, the through hole is away from a part of the substrate to which a finger is hooked when the connector is removed from the mating connector. With this structure, the substrate can have a predetermined strength without increasing the size thereof and can be prevented from being damaged.

The method for mating the connector device with the mating connector device according to the above-mentioned aspect can image-recognize of the position of the connector and the position of the mating connector by using the single image sensor when the connector device is used. Thus, a structure of a mating system for mating the connector with the mating connector can be simplified, and image processing thereof can be simplified.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a top view showing a connector device according to an embodiment of the present invention.

FIG. 2 is a bottom view showing the connector device of FIG. 1.

FIG. 3 is a top view showing a connector included in the connector device of FIG. 1.

FIG. 4 is a perspective view showing the connector of FIG. 3.

FIG. 5 is a perspective view showing a modified example of the connector of FIG. 4.

FIG. 6 is a top view showing a mating connector device provided with a mating connector mateable with the connector device of FIG. 3.

FIG. 7 is a side view for describing a mating process in which the connector device of FIG. 1 and the mating connector device of FIG. 6 are mated with each other. The connector of the connector device and the mating connector of the mating connector device are apart from each other in the up-down direction and in the width direction.

FIG. 8 is another side view for describing the mating process in which the connector device of FIG. 1 and the mating connector device of FIG. 6 are mated with each other. The connector and the mating connector are apart from each other in the up-down direction while they are identical with each other in the width direction.

FIG. 9 is yet another side view for describing the mating process in which the connector device of FIG. 1 and the mating connector device of FIG. 6 are mated with each other. The connector and the mating connector are mated with each other.

FIG. 10 is a perspective view showing a first electrical connector and a second electrical connector which are disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

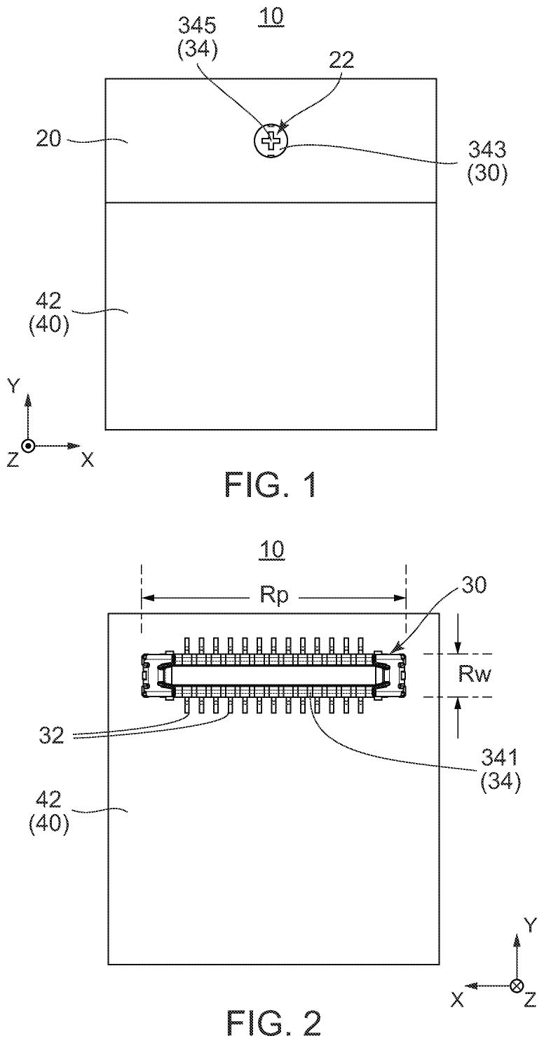

Referring to FIGS. 1 and 2, a connector device 10 according to an embodiment of the present invention is provided with a substrate 20 and a connector 30 which is joined to the substrate 20. In the present embodiment, the connector device 10 is further provided with a flexible printed circuit board 40, and the connector 30 is joined to the substrate 20 via the flexible printed circuit board 40. In the present embodiment, the substrate 20 functions as a reinforcing plate. However, the present invention is not limited thereto. In the present invention, the flexible printed circuit board 40 is not essential. The present invention is applicable to a connector device which does not have the flexible printed circuit board 40 but has a rigid circuit board as the substrate 20.

As understood from FIGS. 1 and 2, the substrate 20, the flexible printed circuit board 40 and the connector 30 are arranged in this order in an up-down direction. In other words, the flexible printed circuit board 40 is sandwiched between the substrate and the connector 30 in the up-down direction. Specifically, the connector 30 is mounted on a lower surface of the flexible printed circuit board 40 while the substrate is fixed on an upper surface of the flexible printed circuit board 40. In the present embodiment, the up-down direction is a Z-direction. A positive Z-direction is directed upward while a negative Z-direction is directed downward.

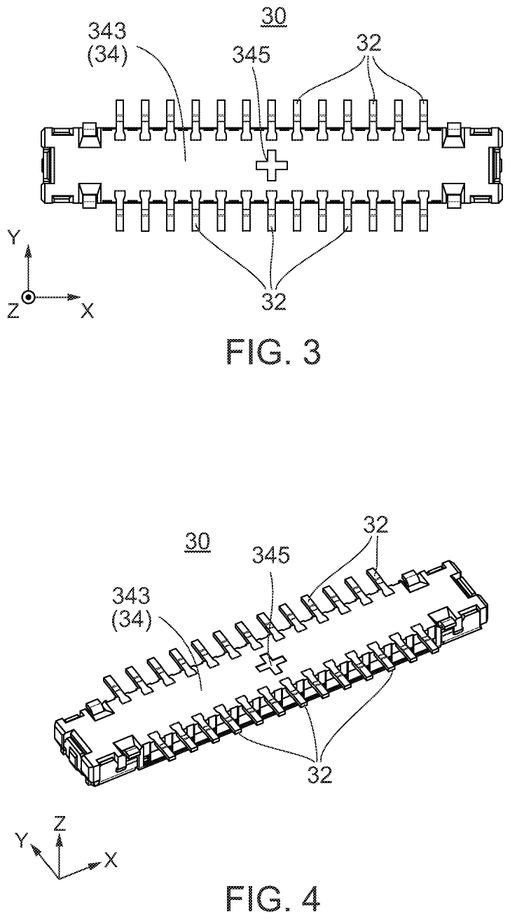

Referring to FIGS. 3 and 4, the connector 30 has a shape which is long in a pitch direction perpendicular to the up-down direction. The connector 30 is provided with a plurality of terminals 32 and a housing 34 which holds the terminals 32. In the present embodiment, the pitch direction is an X-direction.

As shown in FIGS. 1 and 2, the substrate 20 has a rectangular shape which is long in the pitch direction. As understood from FIGS. 1 and 2, the substrate 20 has a size larger than that of the connector 30 in the pitch direction. The connector 30 is away from both ends of the substrate 20 in the pitch direction, and the substrate 20 has a corresponding pitch range Rp corresponding to the connector 30.

As understood from FIGS. 1 and 2, the substrate 20 has a size larger than that of the connector 30 in a width direction perpendicular to both the up-down direction and the pitch direction. The connector 30 is away from both edges of the substrate 20 in the width direction, and the substrate 20 has a corresponding width range Rw corresponding to the connector 30 in the width direction. In the present embodiment, the corresponding width range Rw corresponds to the housing 34 of the connector 30. In the present embodiment, the width direction is a Y-direction.

As mentioned above, in the present embodiment, the substrate 20 has the rectangular shape (see FIG. 1). In other words, the substrate 20 does not have dent portions such as the dent portions 953 formed in the reinforcing plate of Patent Document 1 (see FIG. 10). Accordingly, in the width direction, a size of each of end portions in the pitch direction of the substrate 20 is larger than a size of each of end portions in the pitch direction of the connector 30. In other words, when each of the end portions of the substrate 20 in the pitch direction has a first size in a width direction while each of the end portions of the connector 30 in the pitch direction has a second size in the width direction, the first size is larger than the second size. Thus, the substrate 20 can have a predetermined strength without increasing a size thereof in the width direction more than necessary. Therefore, when the connector 30 is removed from a mating connector 70 (see FIG. 6), the substrate 20 is prevented from being damaged by a stress acting on the substrate 20.

As shown in FIGS. 1 and 2, the flexible printed circuit board 40 has the same size as that of the substrate 20 in the pitch direction. Moreover, the flexible printed circuit board 40 has a size larger than that of the substrate 20 in the width direction. One of edges of the flexible printed circuit board 40 is identical with one of edges of the substrate 20 in the width direction. However, the present invention is not limited thereto. The flexible printed circuit board 40 may have a size smaller than that of the substrate 20 in the pitch direction.

As shown in FIG. 1, the substrate 20 is formed with a through hole 22 which pierces the substrate 20 in the up-down direction and which is closed in a plane perpendicular to the up-down direction. The through hole 22 is not particularly limited in shape, but it may have a polygonal shape. Nevertheless, in consideration of the stress acting on the substrate 20, it is preferable that the shape of the through hole 22 is a round shape. In addition, it is preferable that the through hole 22 is as small as possible in size in order to suppress reduction in strength of the substrate 20. However, it is essential condition that a visual recognition mark 345 mentioned later is visually recognizable through the through hole 22.

As understood from FIGS. 1 and 2, the through hole 22 is only formed within the corresponding pitch range Rp of the substrate 20. In addition, the through hole 22 is only formed within the corresponding width range Rw of the substrate 20. This is for making the visual recognition mark 345 visually recognizable through the through hole 22. In the present embodiment, the through hole 22 is located in the middle of the substrate 20 in the pitch direction. Moreover, in the present embodiment, the through hole 22 is located in the middle of the substrate 20 in the width direction. The position of the through hole 22 is not specially limited, provided that it is located inside the corresponding pitch range Rp and the corresponding width range Rw. Nevertheless, in consideration of a stress acting on the substrate 20 when insertion or removal of the connector 30, it is preferable that the through hole 22 is located in the middle of the substrate 20 in each of the pitch direction and the width direction.

Referring to FIGS. 3 and 4 in addition to FIGS. 1 and 2, the connector 30 has a fitting portion 341 which is mateable with the mating connector 70 (see FIG. 6) and a mounting surface 343 which is a reverse of the fitting portion 341. In the present embodiment, the fitting portion 341 faces downward in the up-down direction and is mateable with the mating connector 70 (see FIG. 6) located downward of the connector device 10 in the up-down direction.

As shown in FIGS. 3 and 4, the mounting surface 343 of the connector 30 is formed with the visual recognition mark 345 which is image-recognizable. In the present embodiment, the visual recognition mark 345 is located in the middle of the connector 30 in each of the pitch direction and the width direction. In the present invention, the position of the visual recognition mark 345 is not specifically limited, but it may be decided in consideration of various factors such as a shape and a size of the substrate 20 and the position of the through hole 22.

As shown in FIGS. 3 and 4, in the present embodiment, the visual recognition mark 345 has a cross shape. However, the present invention is not limited thereto. The visual recognition mark 345 may have any shape other than the cross shape, such as a round shape.

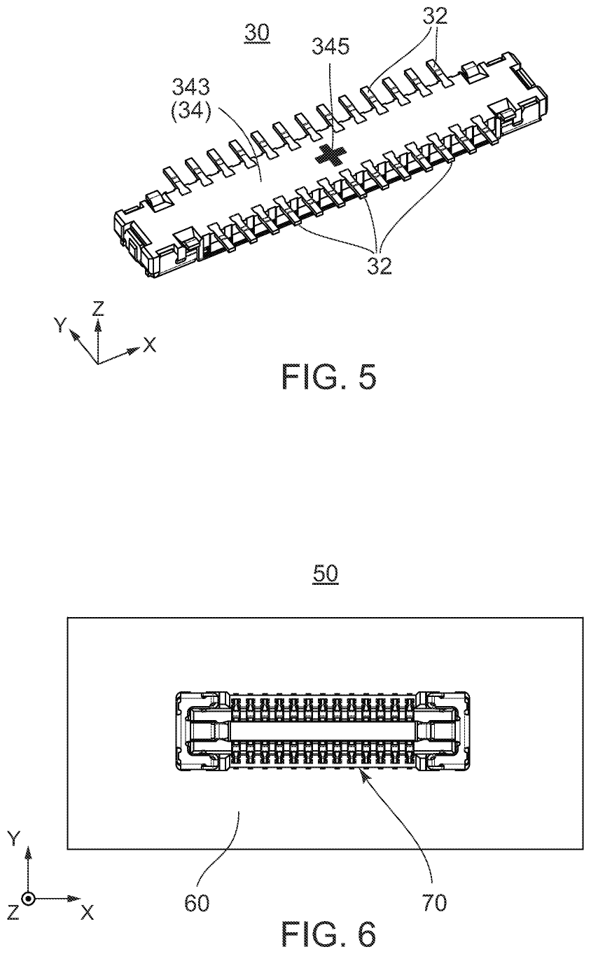

As shown in FIG. 4, in the present embodiment, the visual recognition mark 345 is a concavity depressed downward from the mounting surface 343. However, the present invention is not limited thereto. The visual recognition mark 345 may be a convexity rising upward from the mounting surface 343. Thus, the visual recognition mark 345 may have concave structure, convex structure, or projections and depressions structure. Alternatively, the visual recognition mark 345 may be substantially in the same plane as the mounting surface 343 as shown in FIG. 5. The visual recognition mark 345 may be formed on the mounting surface 343 by a laser process or printing.

As understood from FIGS. 1 and 2, the connector 30 is mounted on the flexible printed circuit board 40 so that the mounting surface 343 is directed to the substrate 20. In the present embodiment, the connector 30 is mounted on the flexible printed circuit board 40 so that the mounting surface 343 faces the flexible printed circuit board 40. Accordingly, the mounting surface 343 of the connector 30 is directed to the substrate 20.

As shown in FIG. 1, the visual recognition mark 345 formed on the mounting surface 343 of the connector 30 is visually recognizable through the through hole 22 formed in the substrate 20. In order to realize this, the connector 30 is mounted on the flexible printed circuit board 40 so that the visual recognition mark 345 overlaps with the through hole 22 in each of the pitch direction and the width direction. Here, the flexible printed circuit board 40 has a film substrate 42 and wirings (not shown) formed on the film substrate 42. The film substrate 42 has transparency so that the visual recognition mark 345 is visually recognizable through the film substrate 42.

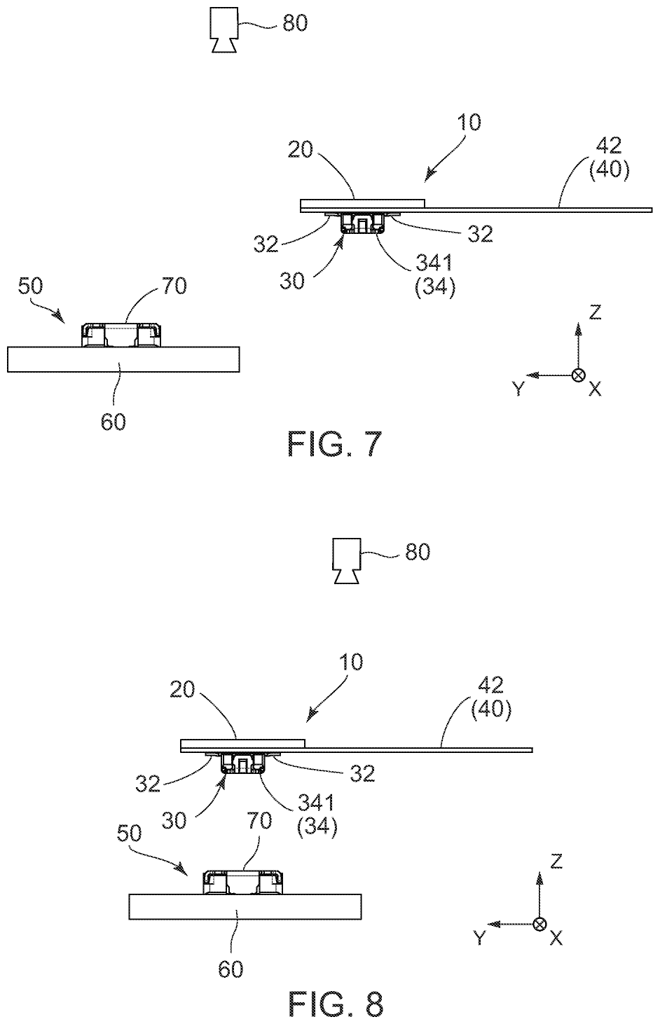

Moreover, the film substrate 42 has a predetermined region corresponding to the visual recognition mark 345, and the wirings are only formed in a region other than the predetermined region. In the present invention, “visually recognizable” means that it can be recognized by an image sensor 80 (see FIG. 7) or that it can be image-recognized. Moreover, “transparency” means that light used for image recognition penetrates it, and the film substrate 42 may not be transparent and colorless. For example, the film substrate 42 may have a color, such as a yellowish brown.

Referring to FIG. 6, a mating connector device 50 is provided with a mating substrate 60 and the mating connector 70 fixed on an upper surface of the mating substrate 60. Mating of the connector device 10 to the mating connector device 50 is carried out as follows.

First, as shown in FIG. 7, the connector device 10 and the mating connector device 50 are respectively located at their initial positions. The initial position of the connector device 10 is upward of the initial position of the mating connector device 50 in the up-down direction. Moreover, the initial position of the connector device 10 is where the visual recognition mark 345 can be image-recognized by the single image sensor 80 located upward of the connector device 10. Furthermore, the initial position of the mating connector device 50 is where the mating connector 70 is image-recognized by the image sensor 80 at least in part.

Next, the connector device 10 and the mating connector device 50 which are respectively located at the initial positions are image-recognized by the image sensor 80.

Next, a control device (not shown) connected to the image sensor 80 calculates a position of the connector device 10 and a position of the mating connector device 50 on a horizontal plane perpendicular to the up-down direction, based on a result of the image recognition made by the image sensor 80. At this time, one of the connector device 10 and the mating connector device 50 may be used as a reference to calculate a relative position of the other of them.

Next, the control device (not shown) operates a manipulator (not shown) on the basis of the calculated position of the connector device 10 and the calculated position of the mating connector device 50 and aligns the connector 30 and the mating connector 70 in the horizontal plane. In detail, as shown in FIG. 8, at least one of the connector device 10 and the mating connector device 50 is moved in the horizontal plane so that the connector 30 is positioned right above the mating connector 70.

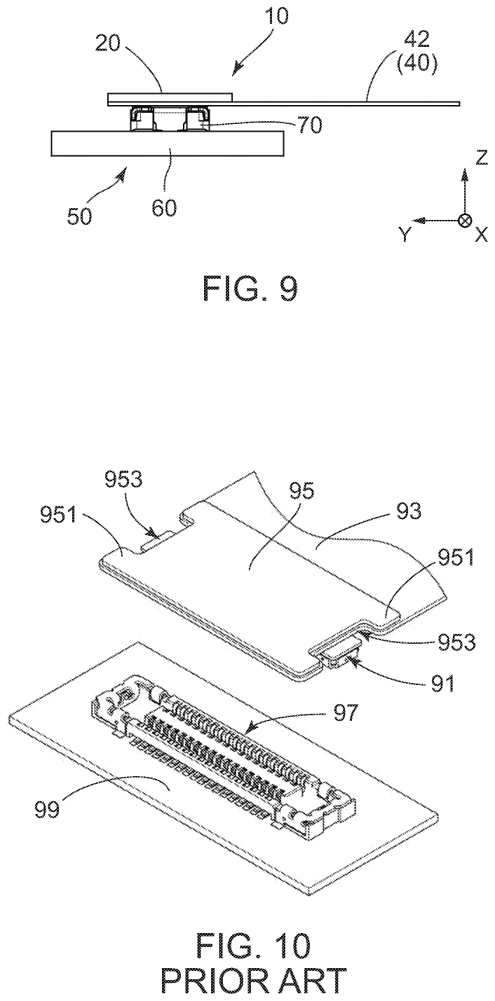

Finally, the control device (not shown) operates the manipulator (not shown) to move one of the connector device 10 and the mating connector device 50 with respect to the other of them in the up-down direction and to mate the connector 30 with the mating connector 70 as shown in FIG. 9.

As mentioned above, according to the method for mating the connector device 10 with the mating connector device 50 according to the present embodiment, the position of the connector device 10 and the position of the mating connector device 50 can be image-recognized by using the single image sensor 80. Accordingly, a mating system in which the connector 30 is mated with the mating connector 70 can be simplified in structure. In addition, image processing in the mating system can be simplified.

When the connector 30 in a mated state (see FIG. 9) is removed from the mating connector 70, fingers are hooked on end portions in the pitch direction of the substrate 20, and forces having a direction to separate the connector device 10 from the mating connector device 50 are applied to the substrate 20. As mentioned above, in the width direction, the size of each of the end portions in the pitch direction of the substrate 20 is larger than the size of each of the end portions in the pitch direction of the connector 30. Accordingly, the substrate 20 has the predetermined strength without increasing the size thereof in the width direction more than necessary. Since the substrate 20 has the predetermined strength, damage to the substrate 20 can be prevented when the connector 30 is removed from the mating connector 70.

Although the specific explanation about the present invention is made above with reference to the embodiments, the present invention is not limited thereto but susceptible of various modifications and alternative forms without departing from the spirit of the invention. For example, although the size of the through hole 22 is larger than the size of the visual recognition mark 345 when viewed along the up-down direction in the present embodiment, the size of the through hole 22 may be smaller than the size of the visual recognition mark 345, provided that a direction and a position of the visual recognition mark 345 can be image-recognized. Moreover, a plurality of through holes 22 and a plurality of visual recognition marks 345 may be provided. Nevertheless, in consideration of reduction in strength of the substrate 20, it is preferable that each of the through hole 22 and the visual recognition mark 345 is one in number.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector device comprising a substrate and a connector which is joined to the substrate, wherein:
the substrate is provided with a through hole which pierces the substrate in an up-down direction and is closed in a plane perpendicular to the up-down direction;
the connector has a fitting portion which is mateable with a mating connector positioned downward of the connector in the up-down direction and a mounting surface which is a reverse of the fitting portion;
the mounting surface faces the substrate;
the mounting surface is formed with a visual recognition mark which is image-recognizable; and
the visual recognition mark is visually recognizable through the through hole.

2. The connector device as recited in claim 1, wherein:
the connector is long in a pitch direction;
the substrate has a size larger than that of the connector in the pitch direction;
the substrate has a corresponding pitch range corresponding to the connector in the pitch direction; and
the through hole is formed only within the corresponding pitch range.

3. The connector device as recited in claim 2, wherein:
the substrate has a size larger than that of the connector in a width direction perpendicular to the pitch direction;
the substrate has a corresponding width range corresponding to the connector in the width direction; and
the through hole is formed only within the corresponding width range.

4. The connector device as recited in claim 1, wherein:
the connector device further comprises a flexible printed circuit board which has a film substrate with transparency and a wiring formed on the film substrate;
the flexible printed circuit board is sandwiched between the substrate and the connector;
the connector is mounted on the flexible printed circuit board so that the mounting surface faces the flexible printed circuit board; and
the substrate is fixed to the flexible printed circuit board.

5. The connector device as recited in claim 4, wherein:
the film substrate has a predetermined region corresponding to the visual recognition mark of the connector; and
the wiring is formed only in a region other than the predetermined region.

6. The connector device as recited in claim 1, wherein the visual recognition mark has a structure of projections and depressions.

7. The connector device as recited in claim 1, wherein the visual recognition mark is a printed mark.

8. The connector device as recited in claim 1, wherein:
the connector is long in a pitch direction;
each end portion of the substrate in the pitch direction has a first size in a width direction;
each end portion of the connector in the pitch direction has a second size in the width direction; and
the first size is larger than the second size.

9. A method for mating the connector device as recited in claim 1 with a mating connector device, wherein the mating connector device comprises a mating substrate and the mating connector fixed on the mating substrate, and wherein the method comprises:
Image-recognizing the connector device and the mating connector device positioned downward of the connector device by using a single image sensor located upward of the connector device;
calculating a position of the connector and a position of the mating connector in a horizontal plane perpendicular to the up-down direction, based on a result of the image-recognizing;
aligning the position of the connector with the position of the mating connector in the horizontal plane, based on the positions calculated by the calculating; and
moving the connector with respect to the mating connector in the up-down direction to mate the connector with the mating connector after the aligning.
